(19) United States
(12) Patent Application Publication
(10) Pub. No.: US 2015/0261192 A1
(43) Pub. Date: Sep. 17, 2015

(54) ELECTRICAL TIMER ATTACHABLE TO PERISHABLE GOODS

(71) Applicant: Zambala LLLP, Henderson, NV (US)

(72) Inventors: Nova T. Spivack, Sherman Oaks, CA (US); Robert Bishop, Winchester, VA (US)

(21) Appl. No.: 14/640,785

(22) Filed: Mar. 6, 2015

Related U.S. Application Data
(60) Provisional application No. 61/954,154, filed on Mar. 17, 2014.

(51) Int. Cl. G04B 47/00; G04G 9/00; G04G 19/06; B65D 25/20

(52) U.S. Cl. CPC G04B 47/00; B65D 25/20; G04G 9/00; G04G 19/06

(57) ABSTRACT

Various embodiments relating to miniature timers, which may be used to measure a fixed or variable period of time using a combination of multiple physical effects. These effects generally include, for example, (1) the charge generated by a matrix of piezoelectric crystals by the application of kinetic force, the motion of a permanent magnet through an inductive coil, a photovoltaic element, or by the harvesting of local energies such as heat, radio frequency waves or sonic energy; (2) the effect of storing a charge in a capacitor; and (3) the effect of certain materials to indicate the presence of an electrical charge, such as liquid crystal matrix, organic LED matrix, electroluminescent material or other material.

### CROSS REFERENCE TO RELATED APPLICATION

This application claims priority to U.S. Provisional Patent Application No. 61/954,154,” entitled “TIMER THAT IS ATTACHED TO A COSMETICS PRODUCT SUCH AS A TUBE OF LIPSTICK,” filed Mar. 17, 2014, the entire contents of which is hereby incorporated herein by reference for all purposes.

### TECHNICAL FIELD

Various embodiments of the present invention generally relate to miniature timer technology. In particular, some embodiments relate to miniature electrical timers that are attachable to perishable goods.

### BACKGROUND

Shelf life is the length of time that a commodity may be stored without becoming unfit for use or consumption, and it applies to foods, beverages, pharmaceutical drugs, chemicals, and many other perishable items. However, because most expiry dates are statically printed on the labels attached to the containers, they are merely guidelines based on statistical data and assuming normal and expected handling and exposure to temperature. Because the traditional printed expiration dates do not reflect the time and condition of the actual use, consuming the goods prior to the expiration date does not guarantee the safety of a food or drug.

### BRIEF DESCRIPTION OF THE DRAWINGS

The present embodiments are illustrated by way of example and are not intended to be limited by the figures of the accompanying drawings. In the drawings:

FIG. 1 is a perspective view showing the basic members of miniature electrical timer according to some embodiments;

FIG. 2 illustrates an example of a first-use safety mechanism in the miniature electrical timer of FIG. 1 according to some embodiments; and

FIG. 3 a diagrammatic representation of a machine in the example form of a computer system 300 within which a set of instructions, for inclusion or being coupled to the timer devices introduced here.

Like reference numerals refer to corresponding parts throughout the figures and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure.

The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication (e.g., a network) between components. The present embodiments are not to be construed as limited to specific examples described herein but rather to include within their scope all embodiments defined by the appended claims.

As previously mentioned, the traditional printed expiration dates do not reflect the time and condition of the actual use, and therefore consuming the goods prior to the expiration date does not guarantee the safety of a food or drug. Some attempts to alleviate this problem include using chemical-based timers; however, the accuracy of chemical timers tends to vary greatly with changes in temperature, humidity and age.

Accordingly, disclosed are various embodiments relating to miniature timers, which may be used to measure a fixed or variable period of time using a combination of multiple physical effects. These effects generally include, for example, (1) the charge generated by a matrix of piezoelectric crystals by the application of kinetic force, the motion of a permanent magnet through an inductive coil, a photovoltaic element, or by the harvesting of local energies such as heat, radio frequency waves or sonic energy; (2) the effect of storing a charge in a capacitor; and (3) the effect of certain materials to indicate the presence of an electrical charge, such as liquid crystal matrix, organic LED matrix, electroluminescent material or other material.

According to the present embodiments, though electrical in nature, the timer requires no external batteries and is more accurate than the chemical timers. In comparison to the chemical-based timers, the electrical timer discussed in the embodiments is more stable over a much wider range of temperatures and humidity levels as well as the age of the timer.

In some embodiments, the timer is adapted to monitor time periods associated with foods, beverages, and other substances including cosmetics, perfumes, pharmaceuticals and chemicals, all of which may have a finite time during which they are suitable and safe for use. Each timer may have a unique identification code, which may be numerical or alpha-numerical.

The timer can utilize certain physical effects to produce a unique method of timing periods shorter than a millisecond to greater than one year. The timer is designed to ensure the safe use of products and to reduce product wastage. It also may be used to give the consumer an indication of the freshness of the product be it cosmetics, perfumes, drugs, foods and beverages, perishable chemicals and other materials. Therefore, the timers introduced here may be very useful in a domestic environment for providing information concerning the remaining period of usefulness of an opened cosmetic or food product. In addition, the introduced timers can be used commercially, or in laboratories, where perishable products such as adhesives or other chemical substances are used.

In some embodiments, the timer may be fabricated at very low cost using low-precision manufacturing techniques, and it may also be fabricated to accommodate a variety of thicknesses, sizes and shapes depending on the manufacturer's requirements.

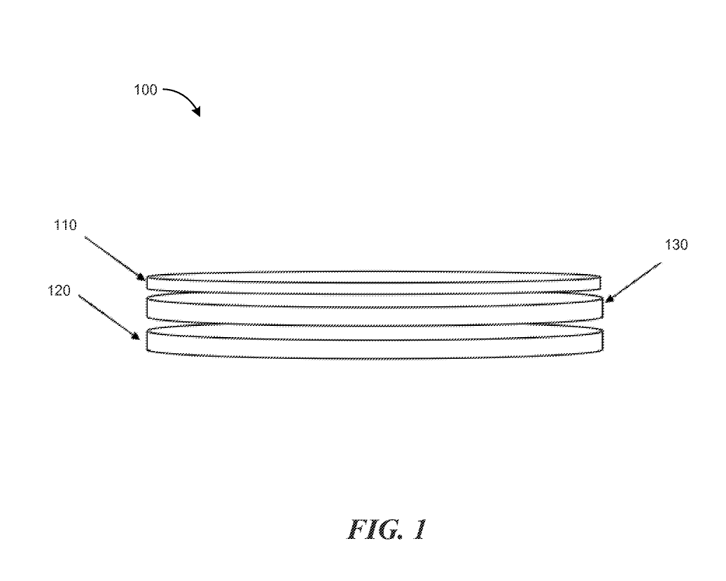

FIG. 1 is a perspective view showing the basic members of miniature electrical timer 100 according to some embodiments. The timer 100 includes a visual indicator 110 (e.g., an electro-reactive element) that can be used for state indication, a capacitor element 120 for the storing of electrical charge, and a triggering element 130 used to generate an electrical charge upon the application of suitable kinetic force. According to some embodiments, the timer 100's operation relies on the charging of the capacitor 120 by applying kinetic force to the triggering element 130. The electrical charges stored in the capacitor are applied to the visual indicator 110, which can be an electro-reactive element such as a liquid crystal matrix, organic LED matrix, electroluminescent material or other material which may be used as an indicator of the timer 100's state.

More specifically, during the design and manufacture phase of the timer 100, the timer 100 may be set to monitor/time a specific time period once the timer 100 has been initiated or triggered. For example, a voltage of the electrical current that is controlled by the triggering mechanism 130 can be designed to change from a first level to a second level over a predetermined duration of time. For use with foods, beverages, cosmetics, pharmaceuticals and other chemicals, it may be preferable for the timer to be initializable only once for maximum safety. However, there may be some applications where it would be desirable for the timer to be re-initialized.

Depending upon the application, the timer 100 can be constructed such that the timer 100 can be manually initiated by a customer when the customer first use a product, or the timer 100 can be initiated at the time of manufacturing by a factory machine or factory worker. If the timer 100 is manufactured so that the customer initiates the timer, it can be engaged in one or more of at least the following example ways: (1) it can automatically engage when a customer first opens the product, (2) it can engage upon purposeful, deliberate initiation by a customer, like pressing a micro switch; or (3) it can engage when there are repeated efforts to turn the product on, pause, stop, reset and/or start it.

In some embodiments, the visual indicator 110 can be adapted to display a visual indicium that represents the passage of a period of time following a first initialization by the consumer/end-user. The timer 100 can thus provide an indication of the maximum length of time the product that can be used by indicating the moment when the product becomes out-of-date and unsafe to use.

The triggering mechanism 130 is configured to charge or to discharge, depending on the embodiments. The triggering mechanism 130 may have a single trigger that is actuated once so as to initialize monitoring the passage of time. Thus, the display 110 may provide no information until the timer 100 has been initialized. Furthermore, the timer 100 can be initiated in a variety of ways, such as when a container is opened, unwrapped or first used, a device is turned on, or a cover, lever, switch, button, lid or other type of moving part is moved sufficiently such that the necessary force is applied to the triggering element 120, causing the timer 100 to become engaged. For example, a housing that forms the container may including a lid member and a main container member, wherein the lid and the main container members are detachably or rotatably attached to each other. The triggering mechanism 130 of the timer 100 can be configured to release the electrical energy from the capacitive element 120 so as to generate the electrical current in response to a mechanical force when the lid and main container members are rotated or detached from each other by the mechanical force. The visual indicium or indicia that is/are displayed by the display element 110 can be dependent upon an amount of time that lapses after the electrical current is first generated.

The timer 100 can also be initialized when the user/consumer or an object exerts force on the triggering element 120 due to the force of gravity, or from the force of a collision.

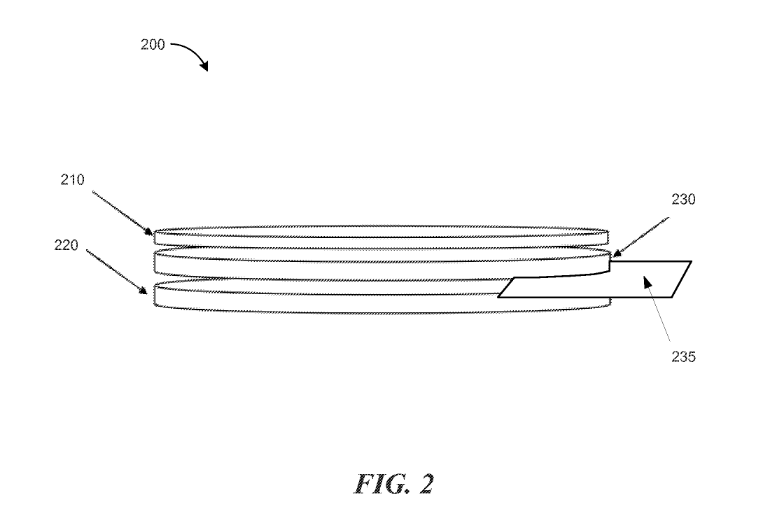

In some embodiments, the timer 100 may also include first-use safety means coupled to the triggering mechanism 130 so as to prevent the timer 100 from being accidentally activated/initialized. The first-use safety means makes it possible to prevent the timer 100 from being accidentally initialized, in which the initialization of the timer 100 cannot take place until after the first-use safety means have been removed or destroyed by the user, for example, when the user wishes to use the food, cosmetic, chemical or other products for the first time. That is to say, the timer 100 can further include a safety mechanism constructed to prevent the charging mechanism from releasing the electrical energy from the capacitive element if the mechanical force is smaller than a predetermined value. An example of a first-use safety mechanism 235 which may be incorporated in the miniature electrical timer 100 of FIG. 1 is illustrated in FIG. 2.

In some embodiments, the timer 100 is attached to a cosmetics product such as a tube of lipstick, mascara, or an eyeliner. Cosmetics products should be replaced after a finite period of usage because they gather bacteria and become unsanitary after repeated use. The timer 100 may provide a means to remind a user that it is the time to replace their cosmetics product. The timer 100 can be manually initiated by the press of a finger, or if desired it can be designed to be automatically initiated the first time the cosmetic product is opened, resulting from the torque or motion of the lipstick or mascara cover being removed, or the lipstick, mascara or eyeliner itself being pushed or rotated within the container tube, with such action resulting in the charging of the timer 100.

Additional ways to initialize the timer 100 may include:

(1) When the product is closed rather than opened, for example when the lid member is closed and thereby presses on the triggering element 130 (which can contain a piezoelectric structure) causing it to charge the timer 100.

(2) When a specific temperature is reached so that an enclosure around the triggering element 130, or the triggering element 130 itself, changes size or shape due to temperature, allowing the triggering element 130 to move, thereby causing it to charge the device 100. Alternatively, the triggering element 130 may be manufactured in a compressed state, like a compressed spring, so that when it is released its movement charges the timer 100.

(3) When the timer 100 receives a special initiation command from a remote broadcasting device, via Bluetooth, WiFi, Near Field Communications (NFC), optical signal (e.g., infrared lights), radio signal, or some other communications mechanism. In other words, in this configuration, the timer 100 can be remotely initiated and controlled (e.g., initiated, paused, stopped, reset, started), without requiring the manual operation by a human of a button or switch on the timer 100 itself—instead the timer 100 can be controlled by remote signals.

In another variation, the timer 100 can be used to create a manually or automatically initiated delayed switch for any kind of electrical device. When the timer 100 runs out, electrical current is allowed to flow, which then causes a switch to turn on to activate the electrical device.

As an alternative to charging, in some embodiments, the triggering mechanism 130 can be a discharging mechanism, which may be electrically coupled to the capacitive element 120 and the visual indicator 110. The discharging mechanism can be configured to: (1) via a first electrical path, discharge the electrical energy from the capacitive element at a first rate, and (2) in response to the lid and main container members being rotated or detached from each other by a mechanical force, release the electrical energy from the capacitive element at a second rate via a second electrical path. The first mode can be before the first use of the product, for example. The discharging mechanism can discharges the capacitive element 120 at a regular rate, the process of which can be initiated when the product is first manufactured. The second mode can be, for example, an accelerated rate at which the discharging mechanism can discharge the capacitive element 120 when the consumer first uses the product.

With regard to the visual indicator element 110, in some embodiments, it may display a visual indication to signal that a time period, or a proportion of a time period, has elapsed. The indication of the expiration of the time period is preferably visual, i.e. perceptible to the eye, and, for example, can be in written form, comprising alphabetical, numerical, alphanumerical, or non-alphanumerical signs, or in the form of different colors or different shades of color. The visual indication may be used alone or in combination: different colors, a segmented display, numbers, or other appropriate visual indicia; the timer 100 may display an initial indicia at the beginning of the time period and a different indication at the end of the time period. In one example, the visual indicator 110 displays different indicia based on a voltage of the electrical current at the input.

It should be understood that, other suitable methods can be used to monitor the passage of time so long as a change occurs with the indicia to indicate (1) the expiration of the “usable” or safe time for the consumer to use, apply, or otherwise consume the product, or (2) that the particular cosmetic or food or chemical item must be used within a certain time period such as, for example, a day or a number of hours. It should also be noted that radio frequency identification (RFID), WiFi, NFC, Bluetooth or other localized or long-distance broadcast technologies can be incorporated into the timer 100's features so that the timer 100 transmits its specific identification number and the current state of the timer 100 including, for example, that the timer 100 has been activated, how long it has been activated, how much time is left on the product's useful life span, to a selected receiver or receivers, including but not limited to nearby mobile devices such as phones, tablets, etc.

In one form, the visual indicator 110 may be a digital display. The display can show a time period indicating the remaining safe and useful life of the product, or expiration of the safe and useful life of the product. In another form, the visual indicator 110 may be, for example, a green and red LED display. In this embodiment, when the timer 100 is activated, a green LED display can appear and remain green until a safe time period has elapsed. When the safe time period lapses, the green LED turns off and the red LED turns on, indicating that the cosmetic, food, or chemical product is no longer safe for the customer to use. The visual indicator 110 statically displays a select visual indicium (e.g., red, using the above example) among the one or more visual indicia indefinitely without electricity after a voltage of the electrical current drops to a certain level.

In yet another form, the visual indicator 110 can include both a changeable indicia such as the colored organic LEDs and a digital display preferably showing a time period of minutes, hours, days or any period of time. In this configuration, when the triggering mechanism 130 (e.g., an On button) is actuated, an organic LED of one color turns on and the digital display starts to count down or up; this organic LED remains on until the timer 100 has counted through the preset time period. At the end of the time period, this organic LED turns off and an organic LED of another color turns on. In still another form, the timer 100 may project an image that is one color in its entirety when the timer is activated. As the time cycle advances, this image projection fades away until the preset time period is reached. At that time, the projected image turns into another color, indicating that the cosmetic or food or chemical or other product is no longer safe to use.

In another form, the timer 100 can be designed to display a particular message at a particular time, or a series of messages at different points in time as time passes. For example, when the timer 100 is first activated for a product it could display the words “Fresh” or “New” or some other similar indication, and as time passes, the timer 100 later could indicate the passage of time by indicating the remaining days left for safe use of the product, such as “7 days left”, “6 days left”; at a certain time the timer could state, for example, that the product is “Old” and finally that the product has “Expired”.

In still another form, the timer 100 can be combined with additional computing elements that together form a small computer, including but not limited to a local random access memory, a local computer processor, and additional integrated computer hardware such as a still or video camera, a microphone, other sensors for location, altitude, temperature, velocity and acceleration, orientation, etc., one or more light sources such as LEDs, and input/output ports.

In another form, the timer 100 can be miniaturized and fabricated as an integrated circuit on a thin film, flexible surface, or chip—or in the form of a label, small sticker or object that can be easily attached to various types of surfaces, either temporarily or permanently. The sticker could use adhesive, magnets, Velcro™, or micro-scale adhesion, to name just a few ways it could be attached to things. The timer 100 could also be fused to things via welding, etc., packaged into an embeddable unit to include in other products, or put into a hypoallergenic capsule that is embedded beneath the skin, or in bone, or swallowed for temporary use.

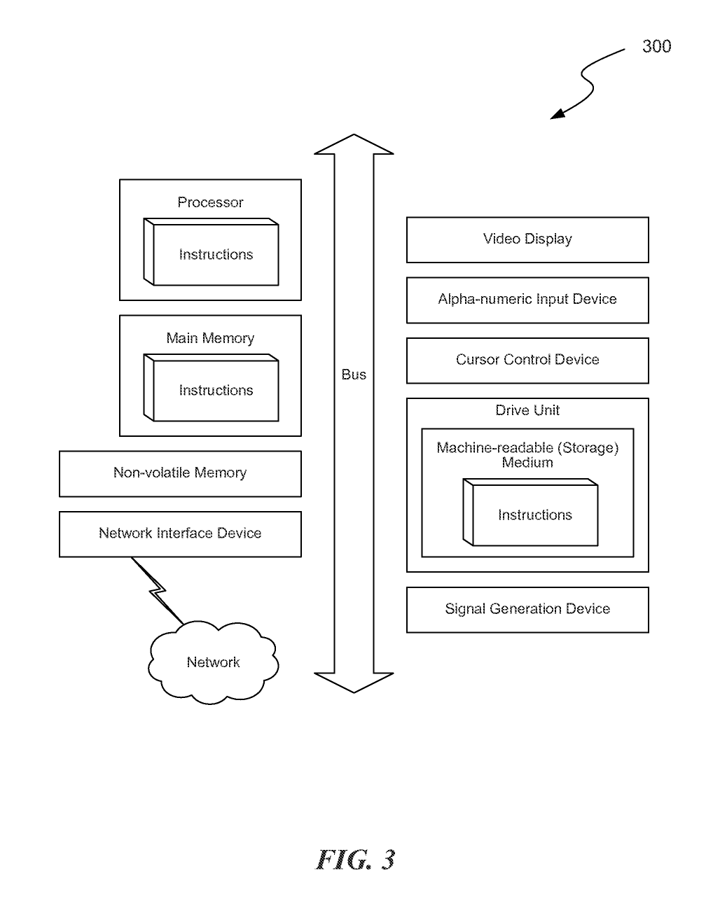

FIG. 3 a diagrammatic representation of a machine in the example form of a computer system 300 within which a set of instructions, for inclusion or being coupled to the timer devices introduced here.

The machine 300 may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute instructions to perform any one or more of the methodologies discussed herein.

The example computer system includes a processor (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory, and a non-volatile memory, which are configured to communicate with each other via a bus. The computer system may further include graphics display unit (e.g., a plasma display panel (PDP), a liquid crystal display (LCD), a projector, or a cathode ray tube (CRT)). The computer system may also include alphanumeric input device (e.g., a keyboard), a cursor control device (e.g., a mouse, a trackball, a joystick, a motion sensor, a touch screen, or other pointing instrument), a storage unit, a signal generation device (e.g., a speaker), and a network interface device, which also are configured to communicate via the bus.

The storage unit includes a machine-readable medium on which is stored instructions embodying any one or more of the methodologies or functions described herein. The instructions may also reside, completely or at least partially, within the main memory or within the processor (e.g., within a processor's cache memory) during execution thereof by the computer system, the main memory and the processor also constituting machine-readable media. The instructions may be transmitted or received over a network via the network interface device.

While machine-readable medium is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium that is capable of storing instructions for execution by the machine and that cause the machine to perform any one or more of the methodologies disclosed herein. The term “machine-readable medium” includes, but not be limited to, data repositories in the form of solid-state memories, optical media, and magnetic media.

The foregoing description of the invention has been presented for purposes of illustration and description and is not intended to be exhaustive or to limit the invention to the precise form disclosed. Many modifications and variations are possible in light of the above teaching. For example, there are several additional applications for the carbon nanotube signal modulators taught herein that would be considered by one of skill. The embodiments disclosed were not intended to be all-inclusive but, rather, were meant only to explain the principles of the invention and its practical application to thereby enable others skilled in the art to best use the invention in various embodiments and with various modifications suited to the particular use contemplated.

What is claimed is:

1. A container apparatus comprising:
a housing including a first member and a second member, wherein the first and second members are detachably or rotatably attached to each other; and
an electrical timer including:
a capacitive element for storing electrical energy;
a visual indicator having an input for receiving electrical current and a display element operable to display one or more visual indicia based on the electrical current; and
a charging mechanism coupled to the capacitive element and the visual indicator, the charging mechanism is configured to release the electrical energy from the capacitive element so as to generate the electrical current in response to a mechanical force when the first and second members of the housing are rotated or detached from each other by the mechanical force,
wherein which of the one or more visual indicia is displayed is dependent upon an amount of time that lapses after the electrical current is first generated.

2. The apparatus of claim 1, further comprising:
a safety mechanism constructed to prevent the charging mechanism from releasing the electrical energy from the capacitive element if the mechanical force is smaller than a predetermined value.

3. The apparatus of claim 1, wherein the visual indicator displays different indicia based on a voltage of the electrical current at the input.

4. The apparatus of claim 1, wherein a voltage of the electrical current is configured to change from a first level to a second level over a predetermined duration of time.

5. The apparatus of claim 1, wherein the visual indicator statically displays a select visual indicium among the one or more visual indicia indefinitely without electricity after a voltage of the electrical current drops to a certain level.

6. The apparatus of claim 1, wherein the visual indicator includes one or more of: a liquid crystal matrix, an organic LED matrix, and an electroluminescent material.

7. A container apparatus comprising:
a housing including a first member and a second member, wherein the first and second members are detachably or rotatably attached to each other; and
an electrical timer including:
a capacitive element for storing electrical energy;
a visual indicator having an input coupled to the capacitive element for receiving the electrical energy and a display element operable to display one or more visual indicia based on an residual amount of the electrical energy; and
a discharging mechanism coupled to the capacitive element and the visual indicator, the discharging mechanism is configured to: (1) via a first electrical path, discharge the electrical energy from the capacitive element at a first rate, and (2) in response to the first and second members of the housing being rotated or detached from each other by a mechanical force, release the electrical energy from the capacitive element at a second rate via a second electrical path.

8. The apparatus of claim 7, wherein the second rate is higher than the first rate.
